(19) United States
(12) Patent Application Publication
(10) Pub. No.: US 2015/0127408 A1
(43) Pub. Date: May 7, 2015

(54) STATIC SCHEDULE REACCOMMODATION

(71) Applicant: Profusion Corp., Tortola (VG)

(72) Inventor: Harold Roy Miller, Toronto (CA)

(21) Appl. No.: 14/530,484

(22) Filed: Oct. 31, 2014

Related U.S. Application Data
(60) Provisional application No. 61/898,868, filed on Nov. 1, 2013.

(51) Int. Cl. G06Q 10/06; G06Q 50/12; G06Q 20/38

(52) U.S. Cl. CPC G06Q 10/06313; G06Q 20/387; G06Q 50/12
USPC 705/7.23

(57) ABSTRACT

A method for reaccommodating of at least one passenger during irregular operations is disclosed. The method includes continuously receiving transportation information from a transportation system. Based on the transportation information and predefined rules, a reaccommodation event associated with the irregular operations is determined. The passenger affected by the reaccommodation event is identified and data concerning the passenger is received. The data may include personal data, itinerary information, and status information concerning the passenger. The passenger can be prioritized based on the received data. Based on the prioritizing and the transportation information, at least one reaccommodation option is generated and provided to the at least one passenger. The passenger can select or decline the provided option. The passenger is reaccommodated in real time based on the received selection.

### CROSS-REFERENCE TO RELATED APPLICATIONS

The present utility patent application is related to and claims priority benefit of the U.S. Provisional Application No. 61/898,868, filed on Nov. 1, 2013 under 35 U.S.C. 119(e). The contents of this related provisional application is incorporated herein by reference for all purposes to the extent that such subject matter is not inconsistent herewith or limiting hereof.

### TECHNICAL FIELD

The present disclosure relates generally to data processing and, more particularly, to reaccommodating passengers during irregular operations.

### BACKGROUND

Use of computerized systems in the travel and hospitality industries is advantageous for customers and suppliers. Computerized reservation systems facilitate storing and retrieving information, as well as conducting transactions related to air travel, hotel reservations, car rentals, or other travel-related activities. However, conventional systems have various limitations, including limited content, legacy environment, latency, and inability to scale.

Additionally, conventional computerized systems used in the travel and hospitality industries provide limited support for suppliers and vendors. Moreover, some operations are still performed manually by operators, making such operations time-consuming and inefficient.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to one example embodiment of the disclosure, a reaccommodation engine is provided. The reaccommodation engine can include at least one processor and a database in communication with the processor. The processor may be configured to continuously receive transportation information from a transportation system. The transportation information can include airline network data, available flights data, available seats data, pricing data, and so forth. The processor may be further configured to determine, based on the transportation information, at least one reaccommodation event associated with the irregular operations according to predefined rules and determine at least one passenger affected by the at least one reaccommodation event. Data concerning the at least one passenger may be received. The data may include personal data associated with the at least one passenger, itinerary information, and status information. Based on the data, the at least one passenger may be prioritized over other passengers in need of reaccommodation. To prioritize the passenger, the processor may analyze the data and, based on the analysis, assign at least one item of the data at least one predetermined value according to priority factors. The priority factors may include at least one of the following: a passenger is a very important person (VIP), a passenger is in danger of missing a connection, a passenger has a medical condition, and so forth.

Based on the prioritizing and the transportation information, the processor may generate at least one reaccommodation option for the at least one passenger in real time. The at least one reaccommodation option may be provided to at least one passenger by email, mobile application, website, or otherwise. The processor may be further configured to receive, from the at least one passenger, a selection of the at least one reaccommodation option and reaccommodate the passenger accordingly.

The database may be configured to store at least the data, the transportation information, predefined rules, and so forth. Additionally, the database may store the at least one reaccommodation option, the selection, and other information.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings.

FIG. 1 illustrates an environment within which systems and methods for passenger reaccommodation during irregular operations can be implemented.

FIG. 2 is a block diagram showing various modules of a reaccommodation engine.

FIG. 3 is a process flow diagram showing a method for reaccommodating of passengers during irregular operations.

FIG. 4 shows a consolidated diagram of data flow in a transportation system associated with an airline.

FIG. 5 illustrates receiving of travel information and passenger data.

FIG. 6 illustrates receiving of information related to events.

FIG. 7 illustrates receiving of information by a reaccommodation engine.

FIG. 8 illustrates workflows associated with reaccommodation options.

FIG. 9 illustrates policies and rules data flows.

FIG. 10 shows a summary of primary external interfaces and core functional components for the reaccommodation system.

FIG. 11 shows a dashboard screen of the reaccommodation interface.

FIG. 12 shows a flight search screen of the reaccommodation interface.

FIG. 13 shows a flight search results screen.

FIG. 14 shows a flight event screen.

FIG. 15 shows a solution screen.

FIG. 16 shows a solution matrix screen.

FIG. 17 shows attributes that may be associated with passengers.

FIG. 18 shows a flight by flight screen providing reaccommodation details for each flight.

FIG. 19 shows an individual details screen.

FIG. 20 shows a mass disruption simulator screen.

FIG. 21 illustrates a method for search and ranking.

FIG. 22 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In air transportation, irregular operations (IROPS) may be caused by weather conditions, flight delays, flight cancellations, and other events. During irregular operations, passenger itineraries may be disrupted and alternative itineraries may be required. Additionally, IROPS may require re-planning for scheduling and finance, re-allocating an aircraft, a flight crew, maintenance, and so forth. Moreover, there are specific rules defined for operating under conditions associated with irregular operations, thus re-planning and re-allocating may be required to comply with these rules.

Generally speaking, the present technology comprises systems, methods, and media for reaccommodating of passengers in real time using a reaccommodation engine when a schedule of a transportation asset is affected. A change in the schedule of the transportation asset may be caused by a flight delay, a flight cancellation, a shutdown of the airport of origin or destination, weather conditions, and so forth.

The present technology may allow continuously receiving information from various components of a transportation system. Based on the information, reaccommodation events associated with IROPS may be determined in accordance with predefined rules. These events may include a flight delay, a flight cancellation, an airport shutdown, and so forth. The rules may be defined by an airline and adjusted as necessary. Using the transportation information, the reaccommodation engine may determine which passengers are affected by events and receive data associated with those passengers.

The data received by the reaccommodation engine may include personal data of each passenger (e.g., a passenger name record (PNR), passenger route data, passenger status, and so forth). The data may be received in real time, therefore, events associated with the airline operations can be immediately reflected, thereby providing solutions based on an actual situation and available resources. The data may be analyzed to determine specific attributes having predetermined values. The values may be calculated to estimate a priority level associated with each passenger. Thus, the reaccommodation engine may automatically prioritize the passengers based on corresponding priority levels. The prioritization may be multi-variable. For example, several passengers may be VIP passengers; however, other passengers may be in danger of missing a connection. All priority factors may be analyzed by the reaccommodation engine and corresponding priorities may be assigned to the passengers.

Additionally, the reaccommodation engine may consider various impact factors with respect to reaccommodation. For instance, the impact factors may include financial consequences for an airline, connection flights, and so forth. Additionally, the reaccommodation engine may receive airline network information related to the capacity of the airline network with respect to an original destination of a passenger, itinerary sections, and so forth.

Using the passenger priorities and the airline network information, the reaccommodation engine may generate a few reaccommodation options for each of the passengers. The generation process may include analyzing rules, constraints and solutions for the passengers. As a result, one or more reaccommodation options can be generated for each passenger. In some cases, the reaccommodation options for a passenger may include one or more options: a different fare class, a different cabin class, a different flight, and so forth.

Reaccommodation flights may be differentiated by the wait time. Depending on the timing, an additional charge or compensation may be associated with a reaccommodation option. For example, a passenger may be offered compensation if he/she selects an option with a longer wait time. Alternatively, a passenger may select an earlier reaccommodation option associated with an additional charge. Thus, airline expenditures related to compensations of passengers and/or other payments may be minimized.

The reaccommodation options may be provided to the passengers, for example, via a mobile application installed on a mobile device of a passenger. Thus, a passenger may receive a notification related to the available reaccommodation options. The passenger may select one of the options and the selection will be sent to the reaccommodation engine. In some embodiments, the passenger may reject all provided options. If this is the case, the reaccommodation engine may receive the passenger rejection and generate additional options for the passenger.

In some embodiments, the reaccommodation engine may not generate reaccommodation options for all passengers who need reaccommodation because of various rules or restrictions. In this case, an operator may adjust/overwrite the rules or restrictions and run the reaccommodation options generation process again. This procedure may be repeated until all passengers are provided with reaccommodation options.

Using the reaccommodation engine, an airline may rank customers by any desirable characteristics. Any field or a combination of fields associated with passenger data or transportation information may be assigned appropriate values, thus making such field or a combination of fields more or less significant in passenger reaccommodation. Additionally, the reaccommodation engine may allow an airline to receive passenger feedback in a centralized and prompt manner and handle the feedback automatically.

In some embodiments, passengers may be reaccommodated in advance. For example, the reaccommodation engine may receive a flight cancellation notification a few days before the flight. The reaccommodation engine may immediately generate reaccommodation options and send the reaccommodation options to the passengers of the cancelled flight. Thus, the passengers may be informed in advance and have an opportunity to adjust their plans and select a convenient reaccommodation option.

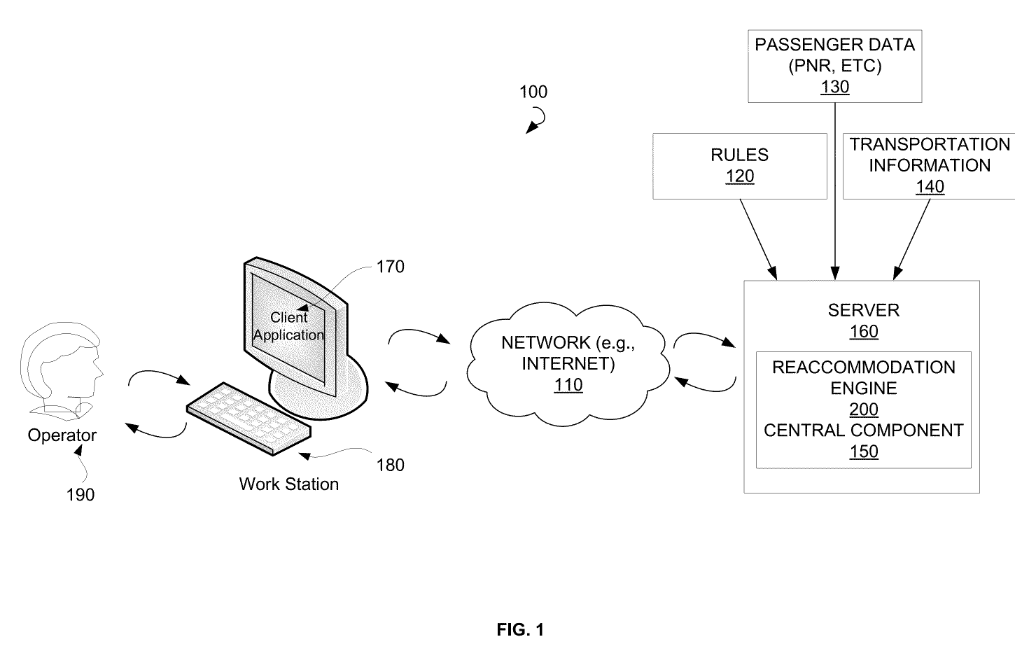

FIG. 1 illustrates an environment 100 within which the systems and methods for passenger reaccommodation during irregular operations can be implemented, in accordance with some embodiments. Passenger reaccommodation may be performed by a reaccommodation engine 200. The reaccommodation engine 200 may be a server-based or distributed application and include a central component 150 residing on the server 160 and one or more client applications 170 residing on work stations 180 and communicating with the central component 150 via a network 110. One or more operators 190 may communicate with the reaccommodation engine 200 via a client application 170 available though a work station 180.

The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (FireWire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 may include a network of data processing nodes that are interconnected for the purpose of data communication.

One or more operators 190 may communicate with the reaccommodation engine 200 via a client application 170 available though a work station 180. The work station 180 may include a laptop, a personal computer (PC), a tablet PC, a smart phone, a handheld computing device, and so forth. The central component 150 of the reaccommodation engine 200 may receive rules 120, passenger data 130, transportation information 140, and other data from various components of airline computerized systems.

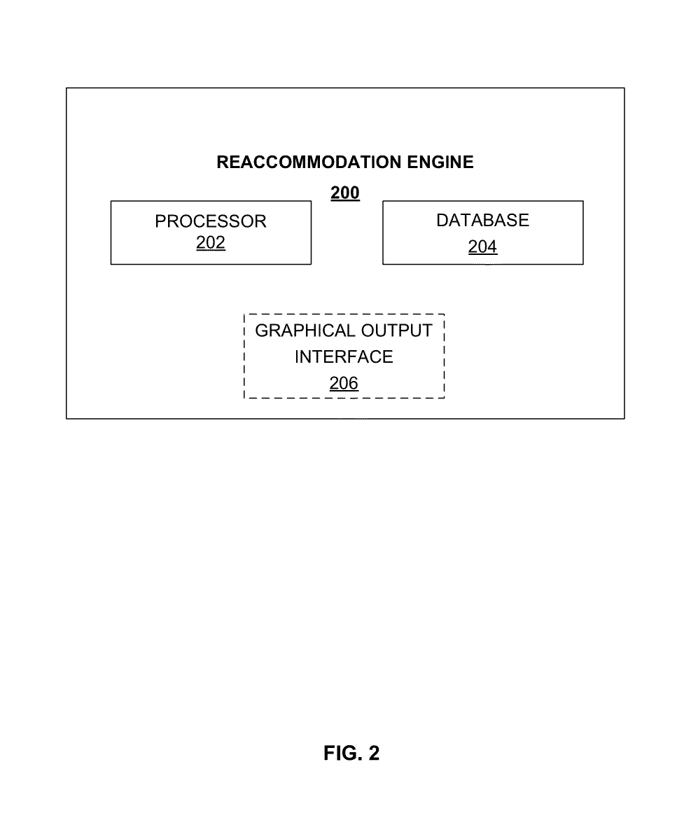

FIG. 2 is a block diagram showing various modules of a reaccommodation engine 200, in accordance with certain embodiments. Specifically, the reaccommodation engine 200 may include at least one processor 202. The processor 202 may be operable to receive transportation information from a transportation system (e.g., PSS). Based on the transportation information, a reaccommodation event associated with IROPS may be determined according to predefined rules. The rules predetermined by the airline may regulate determining of IROPS and further actions associated with IROPS. The predefined rules may identify disruption of passenger itineraries in IROPS associated with weather conditions, flight delays, and flight cancellations. Such events may be associated with re-planning for scheduling and finance, re-allocating an aircraft, re-allocating a flight crew, re-allocating maintenance, and the like. The processor 202 may further determine passengers affected by the reaccommodation event and receive data related to the passengers. The data may include personal data associated with the at least one passenger, itinerary information, status information, and other data.

Furthermore, the processor 202 may be configured to prioritize the passengers according to various priority factors, such as whether a passenger is a very important person (VIP), whether a passenger is in danger of missing a connection, and whether a passenger is associated with a medical condition (e.g., pregnant), and so forth. Prioritization may be multi-variable prioritization. Considering the prioritizing and the transportation information, the processor 202 may generate reaccommodation options and provide the options to the passengers, for example, via the graphical output interface 206. The processor 202 may receive selections of the reaccommodation options from the passengers and reaccommodate the passengers as indicated in their selection. The database 204 may be configured to store the transportation information, predefined rules, passenger data, passenger selections, and so forth.

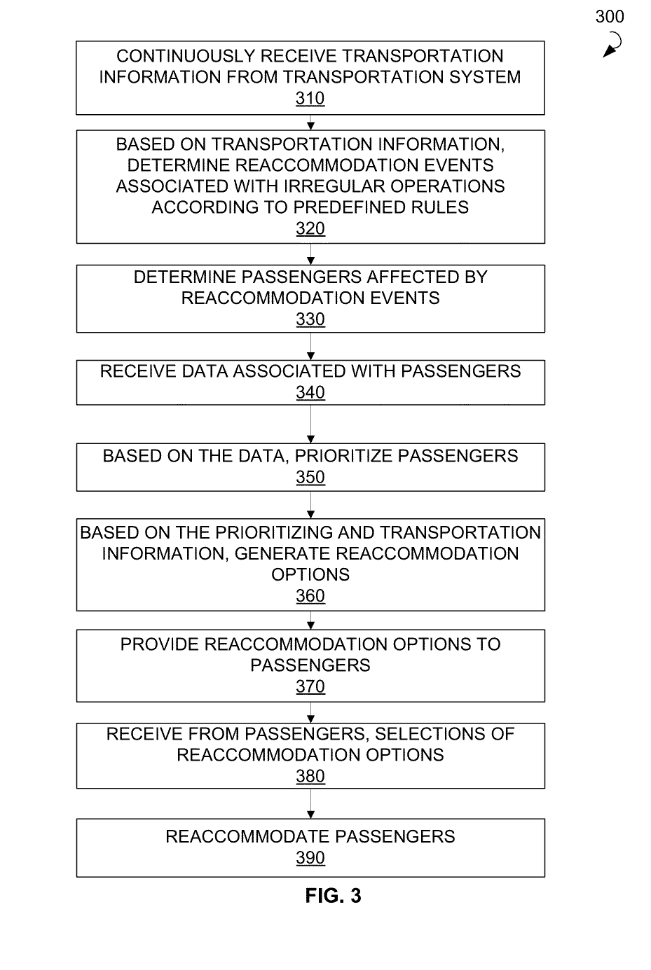

FIG. 3 is a process flow diagram showing a method 300 for reaccommodating passengers during irregular operations within the environment described above with reference to FIG. 1. The method 300 may commence with continuous receiving of transportation information from a transportation system at operation 310. The transportation information may include airline network data, available flights, seats, fare classes, pricing data, and so forth.

The transportation information may be processed to determine reaccommodation events associated with irregular operations at operation 320. For example, such event may include a flight delay, a flight cancellation, an airport shutdown, and so forth. Based on the determination that one or more of the irregular operation conditions occurred, a reaccommodation event may be triggered. The events may be triggered automatically based on predefined triggering rules or triggered manually by an operator. The passengers affected by the events may be determined at operation 330 and data associated with the passengers received by the reaccommodation engine 200 at operation 340. The data may include PNRs, passenger itinerary information, and so forth. The PNR is a record in a database of a computerized reservation system or a Global Distribution System. The PNR may include a plurality of attributes related to the passenger and/or the itinerary, for example, a passenger name, a fare class of each section of the itinerary, a passenger status, and so forth.

The reaccommodation engine 200 may process the data of the passengers according to attribute values predetermined in the reaccommodation engine 200. Based on the processing, the passengers may be prioritized for reaccommodation at operation 350. For example, the passengers with a higher priority may include unaccompanied minors, groups of travelers, pregnant women, VIPs, and so forth. Thus, the passengers with a higher priority may get reaccommodation with a shorter waiting time, better seats, and so forth. In some embodiments, the passengers may be prioritized in the order in which they get access to available inventory across the network.

The reaccommodation engine 200 may find all possible solutions for the passenger according to the transportation information (specifically, the origin and destination of the passenger). However, the passage may not be provided with all of the found solutions. The solutions may be filtered to only provide the solutions for which the passenger qualifies. Based on the prioritizing and the transportation information, the reaccommodation engine 200 may generate reaccommodation options for each of the passengers affected by the reaccommodation events at operation 360. The number of the reaccommodation options generated for each passenger may depend on the attributes of the passenger and predefined policies and rules associated with the attributes. For example, a rule may require that at least two reaccommodation options are generated for each business class passenger.

In some cases, the predefined policies, rules, and/or constraints may prevent generation of reaccommodation options for some passengers. For example, there can be no available options to satisfy all rules and constraints. To address this issue, an operator may review the policies, rules, and constraints preventing generation of reaccommodation options for some passengers and manually relax or overwrite the one or more rules or constraints as appropriate. The generation process may be repeated with the relaxing/overwriting rules or constraints for other passengers.

The generated reaccommodation options may be provided to the passengers at operation 370. The options may be sent to the passengers via email, mobile application, SMS, and so forth. The data associated with a passenger email, mobile number, and so forth may be stored in the PNR of the passenger. The passenger may select one of the received options or provide feedback to the reaccommodation options (for example, reject the received options, ask for alternative options, and so forth). The passenger feedback may be received by the reaccommodation engine 200 at operation 380. Based on the feedback, the reaccommodation engine 200 may take appropriate actions and reaccommodate the passengers. For example, their tickets associated with a cancelled flight may be exchanged for tickets on other flights.

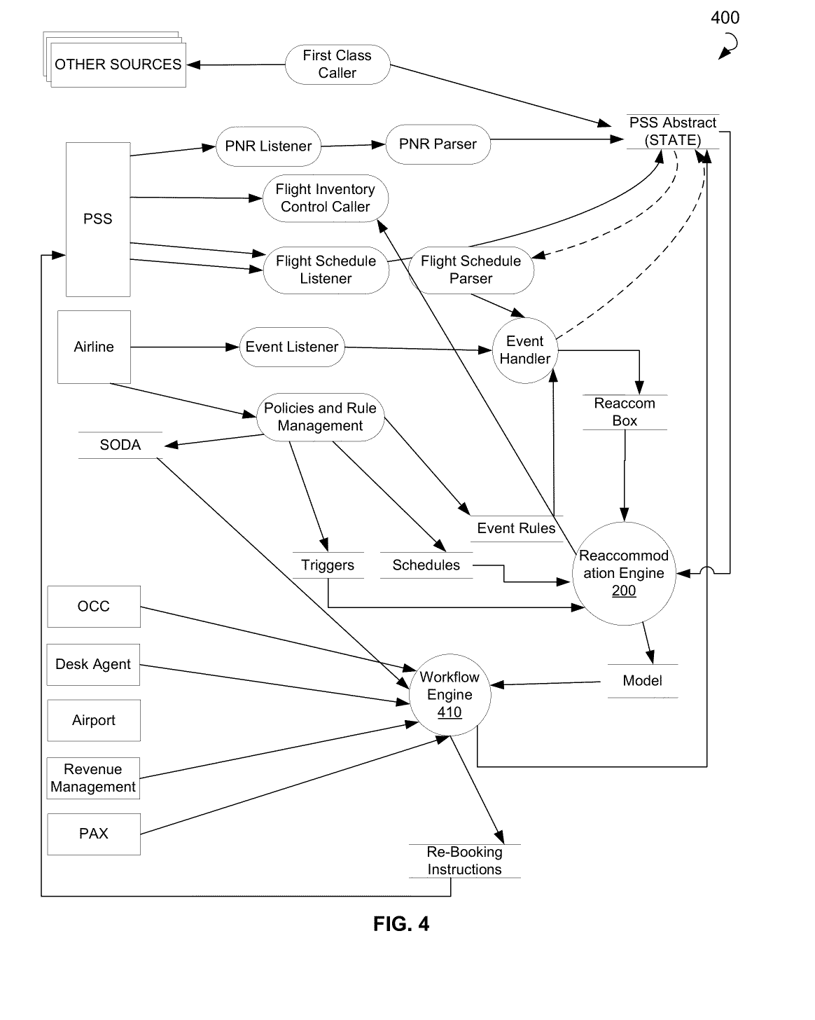

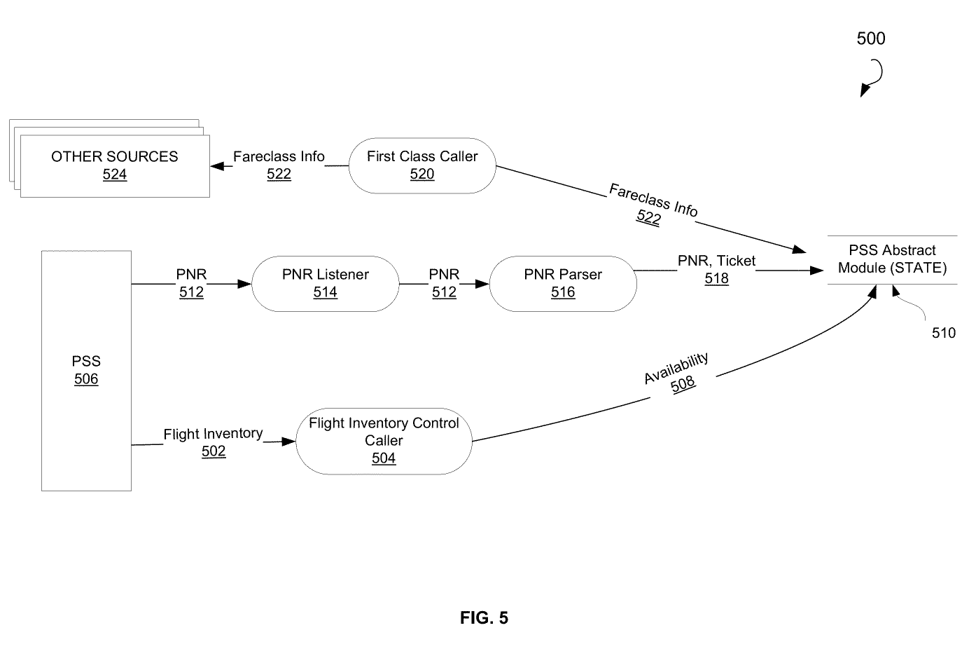

FIG. 4 shows a consolidated diagram 400 of data flows in the computerized transportation system associated with an airline. The diagram 400 illustrates an example process of data submittal by various components of the computerized system. The data includes event information, data of the passengers affected by the events, travel information, policies, rules, and constraints, and so forth. The data is processed by the reaccommodation engine 200 and, based on the processing, reaccommodation options for the affected passengers are generated. The reaccommodation options (proposed solution) are submitted to a workflow engine 410 controlling communications with the passengers and inventory updates according to passenger decisions. Prior to submitting the reaccommodation options, the reaccommodation options may be ranked according to predetermined rules. Based on the ranking, it may be determined which of the options can be offered, in which order, to which passengers, and so forth. Separate data flows will be described in detail below with reference to FIGS. 5-9.

FIG. 5 illustrates receiving 500 of travel information and passenger data in accordance with some example embodiments. Flight inventory information 502 may be received by a flight inventory control caller 504 from a PSS 506 (e.g., HP Shares). The travel information, including seats availability 508, may be transmitted by the flight inventory control caller 504 to a PSS abstract module 510. Additionally, the PSS 506 may provide PNRs 512 to PNR Listener 514. The PNRs 518 may be parsed by PNR Parser 516 and transmitted to the PSS abstract module 510. The PSS abstract module 510 may also receive information from other sources. For example, Fare Class Caller 520 may call fare class information 522 from various sources 524 and pass the fare class information 522 to the PSS abstract module 510.

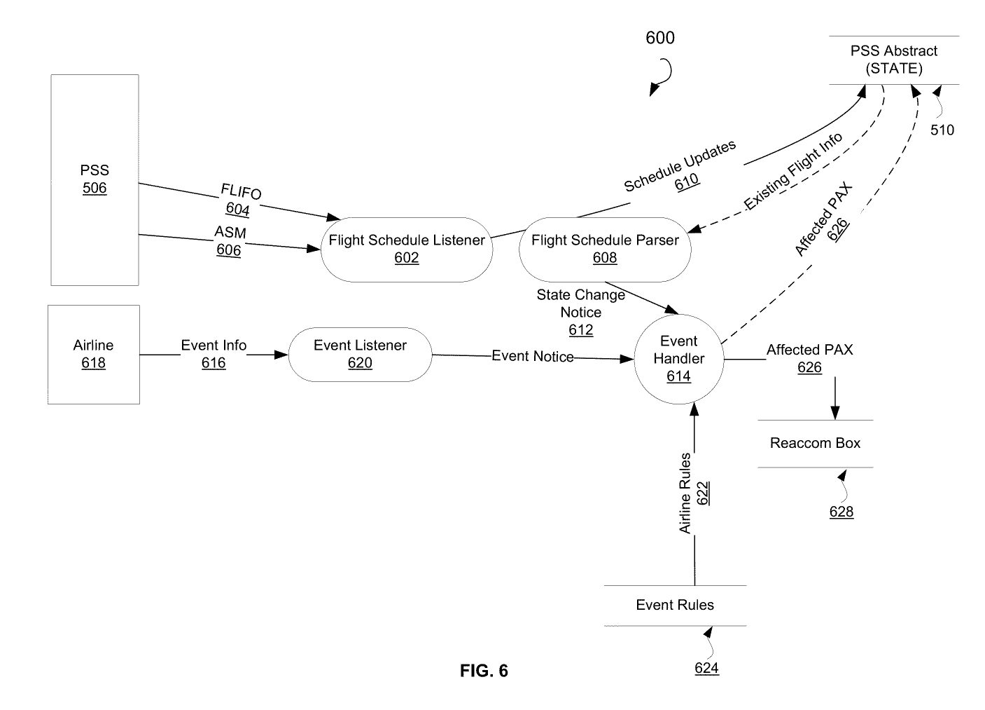

FIG. 6 illustrates receiving 600 of information related to events, in accordance with some embodiments. In an example embodiment, a Flight Schedule Listener 602 may receive schedule information (e.g., flight information (FLIFO 604), available seat miles (ASM 606), and so forth) from the PSS 506. A Flight Schedule Parser 608 may parse the schedule information to determine schedule updates 610, which are transmitted to the PSS abstract module 510. Additionally, state change notices 612 may be transmitted by the Flight Schedule Parser 608 to an Event Handler 614.

The Event Handler 614 may in turn receive event information 616 from an airline 616 via an Event Listener 620. The Event Handler 614 may also receive event rules 624 defined by the airline 618 to airline rules 622, and based on the events and/or rules, determine the passengers (PAX) 626 affected by the events. The information associated with the affected passengers 626 may be transmitted to the PSS abstract module 510 and a reaccom box 628.

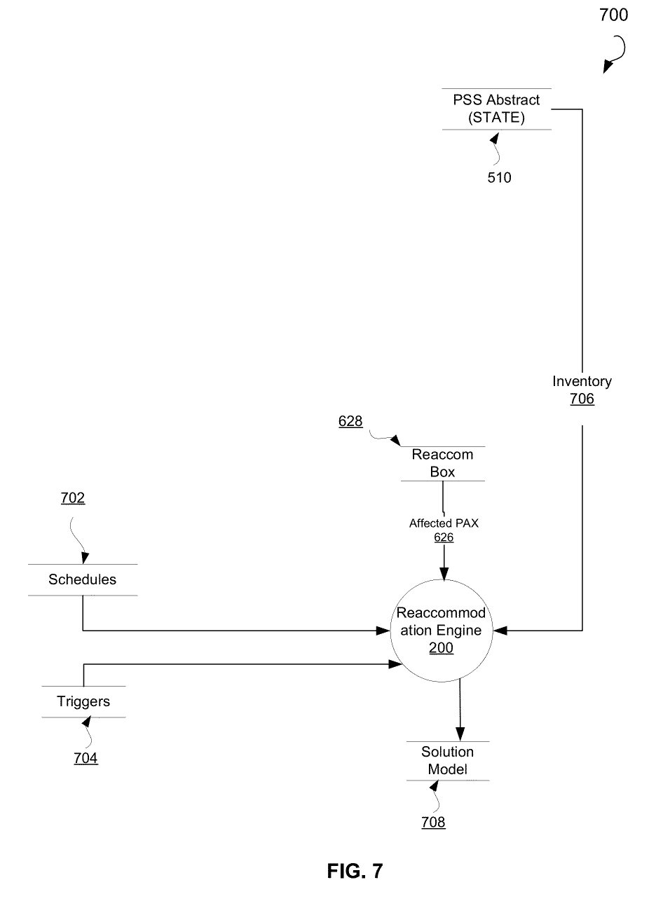

The reaccom box 628, shown by FIG. 7, may forward the information associated with the affected passengers 626 to the reaccommodation engine 200. The reaccommodation engine 200 may additionally receive schedules 702 and other triggers 704, as well as inventory information 706. The inventory information 706 may be furnished by the PSS abstract module 510. The information received may be processed by the reaccommodation engine 200 and a solution model 708 may be generated. The solution model 708 may include reaccommodation options for the affected passengers.

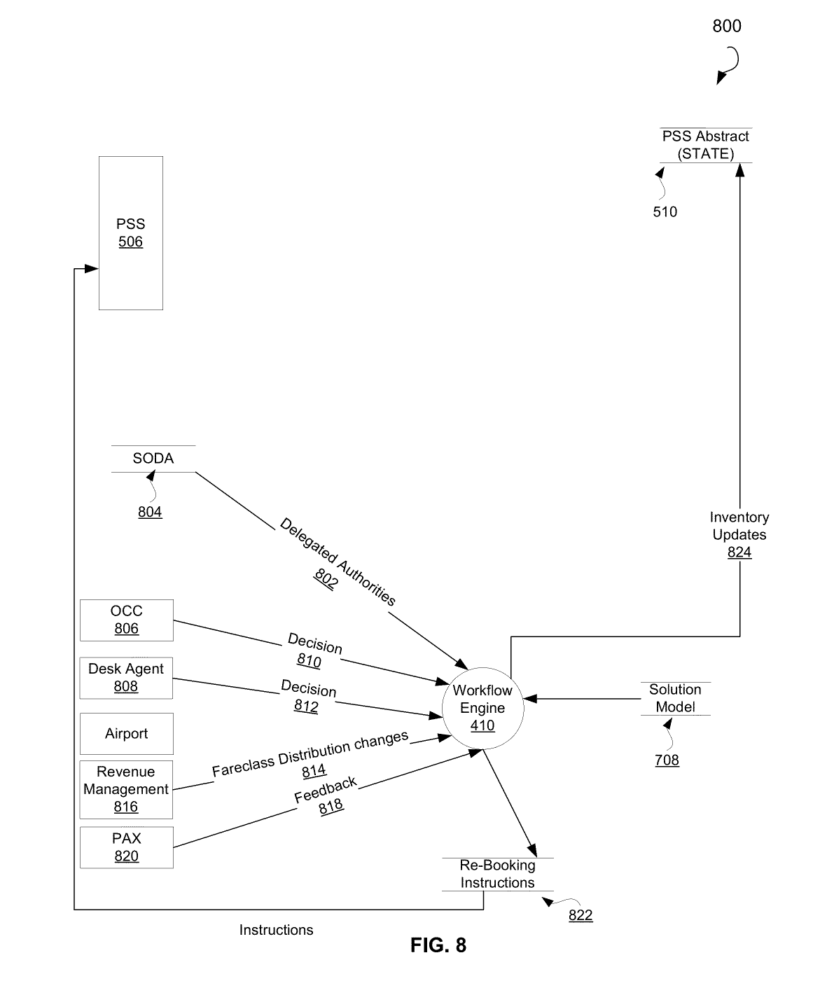

FIG. 8 shows that the solution model 708 may be transmitted to a workflow engine 410, which receives delegated authorities 802 from SODA 804, OCC 806 and desk agent 808 decisions 810, 812, fare class distribution changes 814 from revenue management 816, and feedback 818 from the passengers (PAX) 820. The workflow engine 410 processes the received data and, based on the processing, generates re-booking instructions 822, which are further transmitted to the PSS 506, and inventory updates 824, which are further transmitted to the PSS abstract module 510.

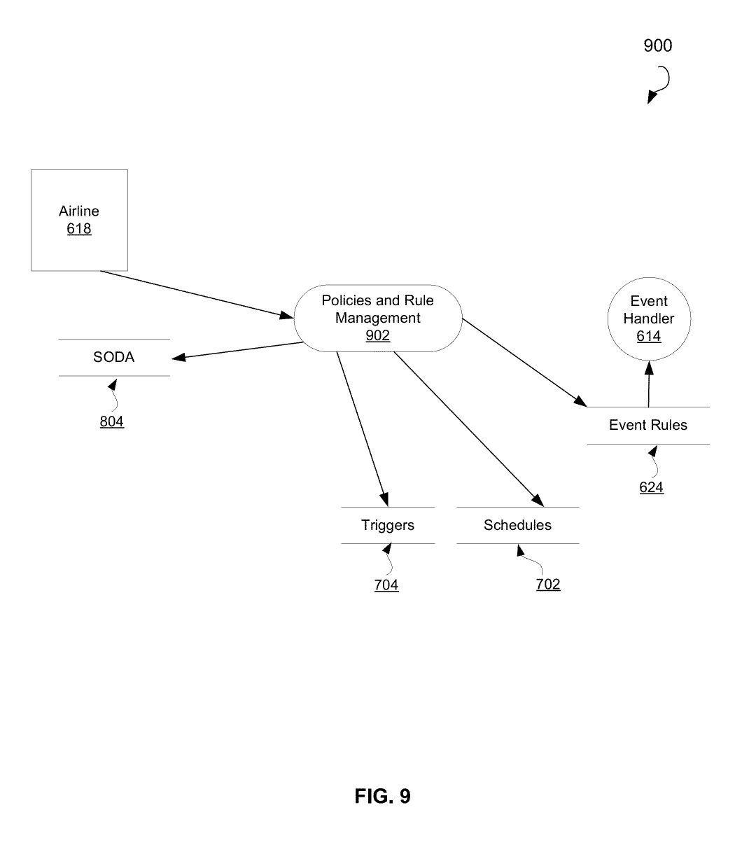

FIG. 9 illustrates policies and rules data flows 900, in accordance with some example embodiments. The airline 618 may predefine policies and rules via a Policies and Rules Management module 902. Based on the rules, the Policies and Rules Management module 902 may provide event rules 624 to the Event Handler 614. Additionally, the Policies and Rules Management module 902 may provide schedules 702 and triggers 704 to the reaccommodation engine 200, as well as delegations and authorities' data to SODA 804.

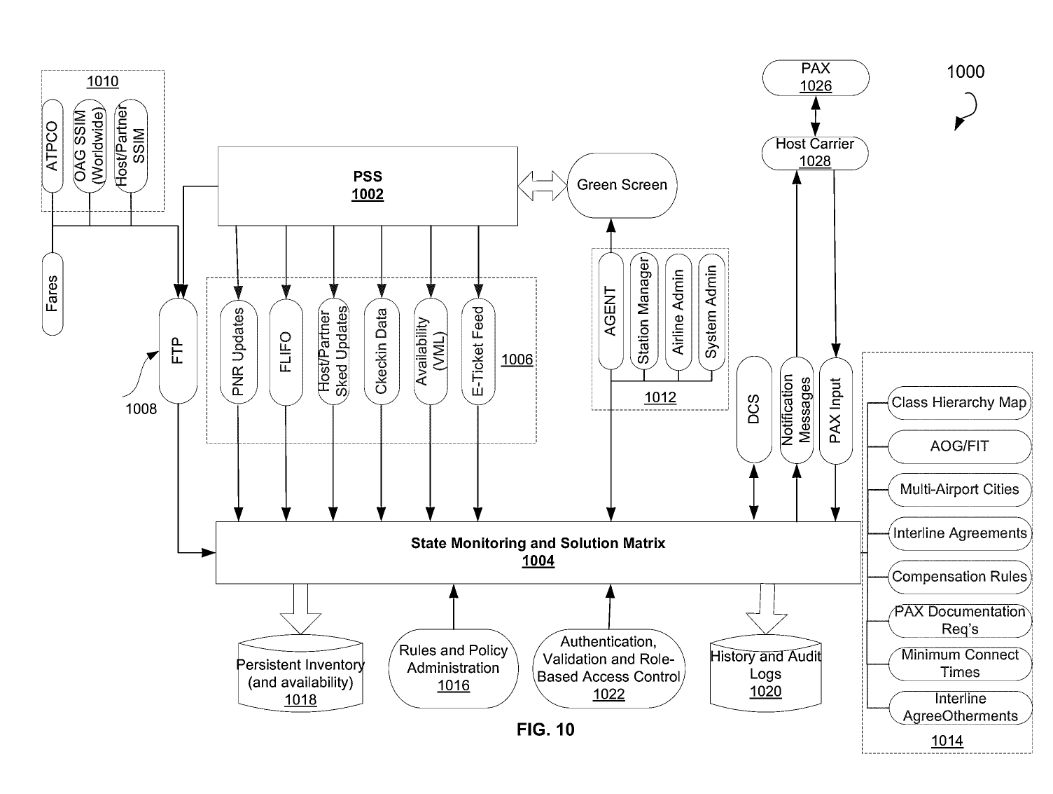

FIG. 10 shows a summary 1000 of primary external interfaces and core functional components for the reaccommodation engine 200. The reaccommodation engine 200 may communicate with a passenger service system (PSS) 1002 via a state monitoring and solution matrix 1004 to receive PNR updates, FLIFO, schedule updates of a host/partners, check-in data, seats availability data, and e-ticket feed 1006. Additionally, information may be received from host/partners Standard Schedules Information Manual (SSIM) 1010 via FTP 1008. The FTP 1008 may be also used to receive PNR Record Locator List from the PSS 1002. Agents, station managers, airline administrators, and system administrators 1012 may communicate with the reaccommodation engine 200 via an HTML interface. The reaccommodation engine 200 may store and process airline network data, rules, and other information (for example, interline agreements, compensation rules, minimum connect times, and so forth) 1014.

The received and stored data may be processed to generate reaccommodation solutions. The rules and policies used to generate reaccommodation solutions may be managed through rules and policies administration module 1016. When the solution is generated, passengers 1026 and/or a host carrier 1028 may be notified about the reaccommodation options and passenger feedback may be received. Reaccommodation information may be stored in a persistent inventory database 1018, as well as history and audit logs 1020. Access to the reaccommodation system may be secured by authentication, validation, and role-based access control 1022.

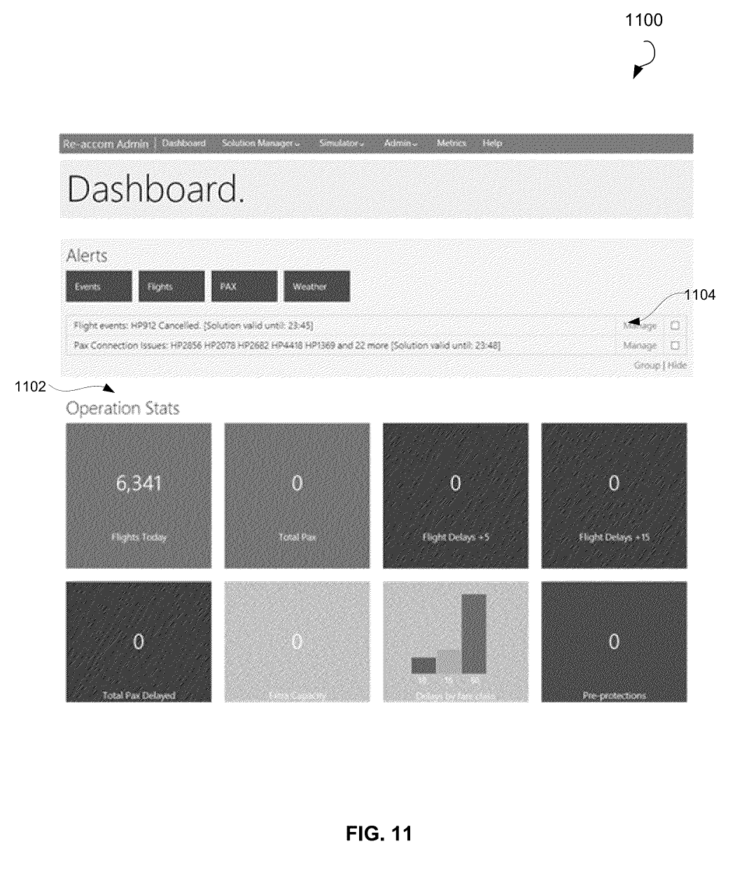

Sample screens of a reaccommodation interface are described further with reference to FIGS. 11-20. FIG. 11 shows a dashboard screen 1100 of the reaccommodation interface. The dashboard screen 1100 may be accessed after login to the reaccommodation engine. The access to the reaccommodation engine 200 may be protected by a password. In various embodiments, password authorization may be replaced and/or combined with other types of authorization, for example, biometric authorization, two-way authorization, and so forth.

The dashboard may provide information concerning the events within an airline network, such as reaccommodation events. Additionally, the dashboard may include operation statistics 1102. The operation statistics 1102 may show the number of passengers for a day, the total number of passengers, delayed flights and delayed passengers, and other information. In some embodiments, the dashboard screen 1100 may include one or more controls configured to perform various operations related to reaccommodation.

One or more events may be shown in an events section 1104. One of the events is related to passenger connection issues, i.e., one or more passengers are missing their connection flights. When the reaccommodation event is received by the reaccommodation engine 200, the reaccommodation solution is generated automatically so the operator does not have to process these issues manually.

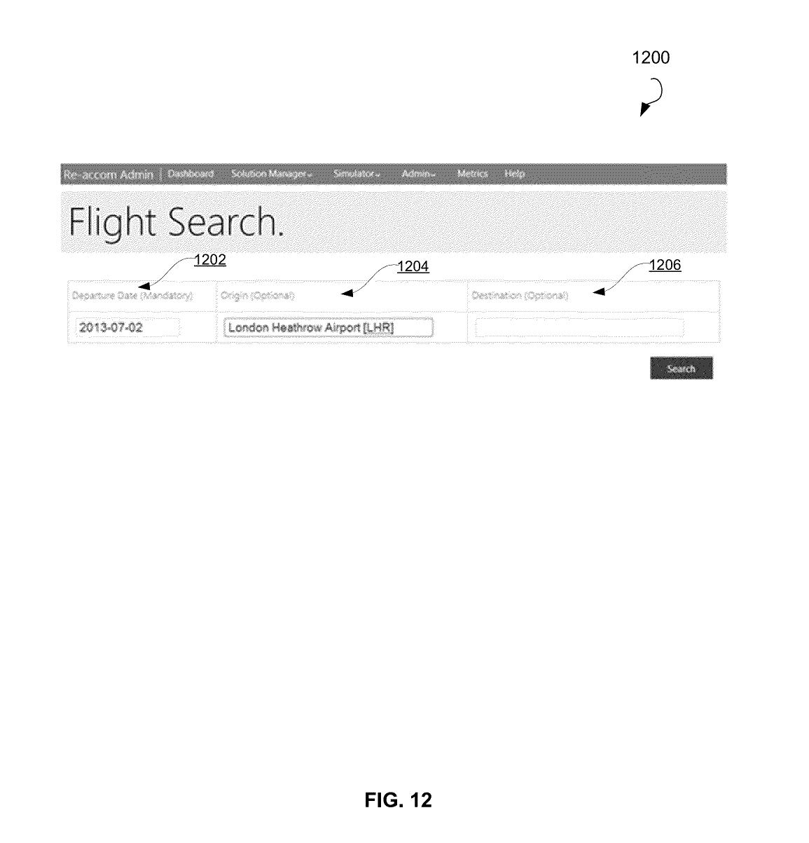

Using the reaccommodation interface, an operator may search data related to a specific flight. The operator may search for a specific flight via a flight search screen shown by FIG. 12. To find a desired flight, the operator may search, for example, by a date 1202, a flight origin 1204, a flight destination 1206, or other data. For example, if the operator enters ‘London Heathrow Airport [LHR]’ as a flight origin and ‘2013-07-02’ as a desired date, the reaccommodation engine may find all the flights departing from the London Heathrow Airport at Jul. 2, 2013.

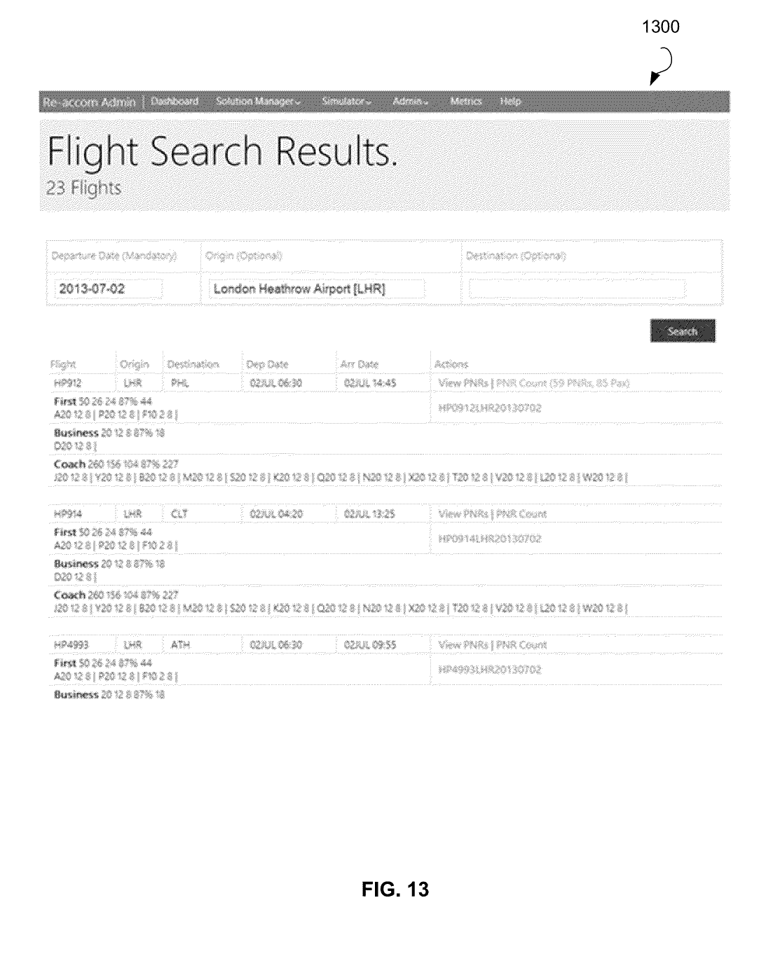

The flights found may be displayed via a flight search results screen shown by FIG. 13. The flights corresponding to the search request may be displayed together with information related to the flight, e.g., flight number, origin, destination, departure and arrival date and time, number of passengers in different class cabins, available actions, and so forth.

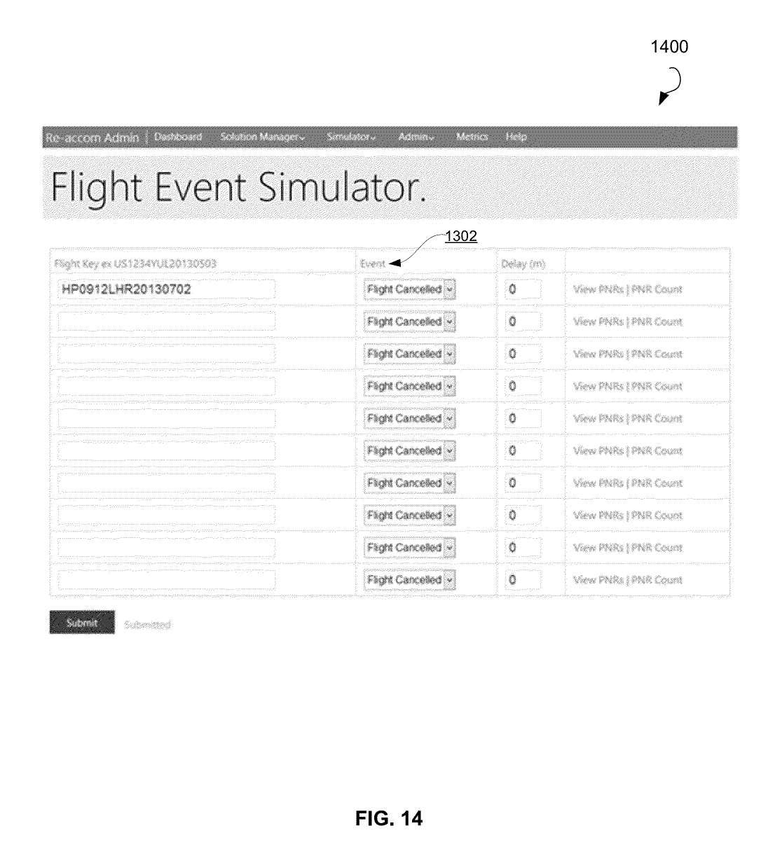

By selecting a desired flight, the operator may be taken to a flight event screen shown by FIG. 14 and select an event 1302 for a flight. For example, the operator may select a ‘flight delayed’ event and specify the delay. Alternatively, the operator may select a ‘flight cancelled’ event. Though the operator may select events manually, the events are normally submitted automatically. The event submitted either manually or automatically may be processed by the reaccommodation engine, corresponding information related to the event may be received, and a solution including possible reaccommodation options may be generated.

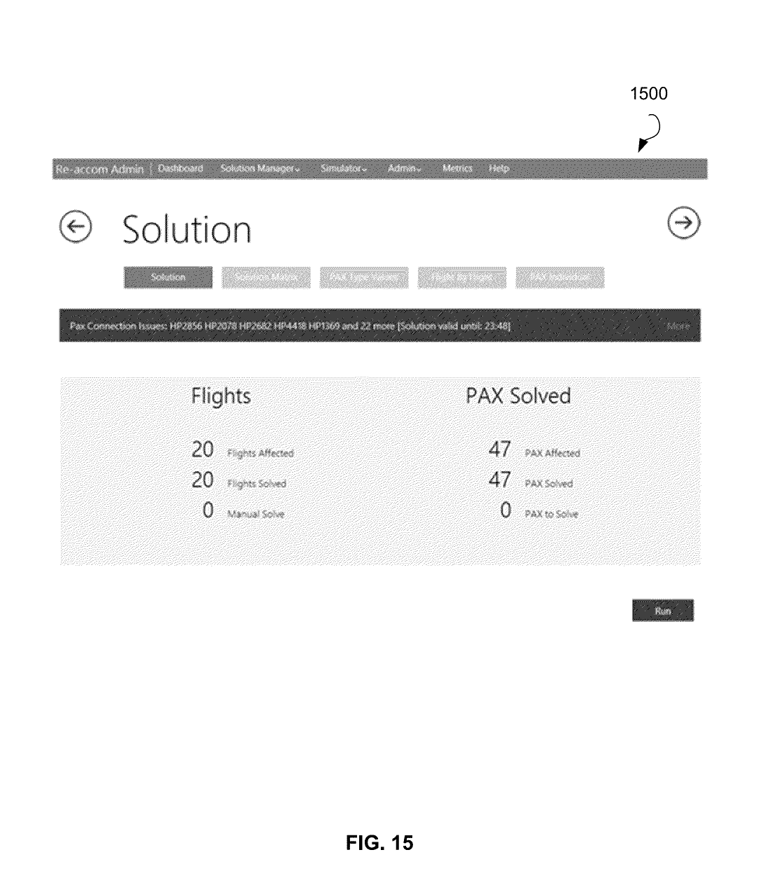

The details concerning the generated solution may be reviewed via a solution screen illustrated by FIG. 15. The solution screen 1500 may provide information concerning the number of flights affected and handled by the event and/or the number of passengers affected, handled, awaiting adjustment, and so forth.

The passengers handled may include the passengers for whom an appropriate reaccommodation options were generated automatically, while the passengers awaiting adjustments may include passengers for whom some specific issues exist. Based on default rules configured for the reaccommodation engine 200, no reaccommodation could be generated to overcome the specific issues. Therefore, an operator intervention may be required to adjust the settings so that reaccommodation options could be generated for the passengers awaiting reaccommodation.

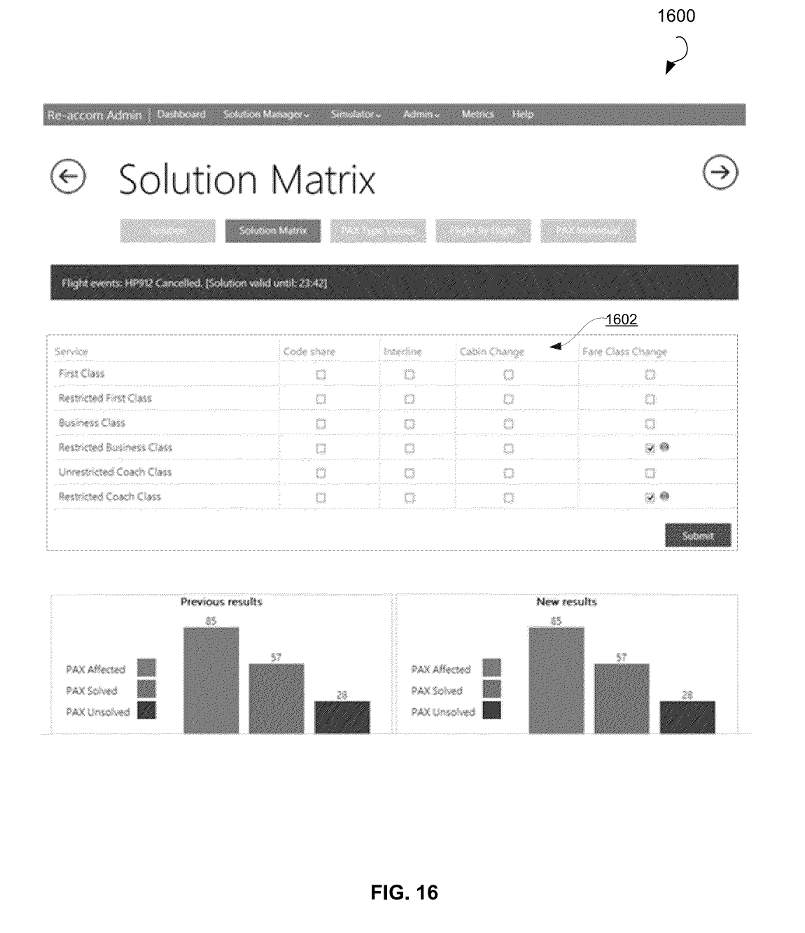

To fix the issues, a solution matrix screen may be used. The solution matrix screen 1600 shown in FIG. 16 may provide information concerning sets of basic rules 1602 that can be relaxed to allow generation of a solution. The rules 1602 causing the issues for the generation of reaccommodation options may be highlighted. For example, one of the issues may include a restricted business class rule. This rule may imply that a business class passenger needs to be reaccommodated to the same class. If this rule is relaxed, a fare class for the passengers awaiting reaccommodation can be changed. When a rule relaxation is submitted, the results of such relaxation may be displayed in the results section. If some passengers are still awaiting reaccommodation after a rule relaxation, other rules highlighted as causing issues may be relaxed.

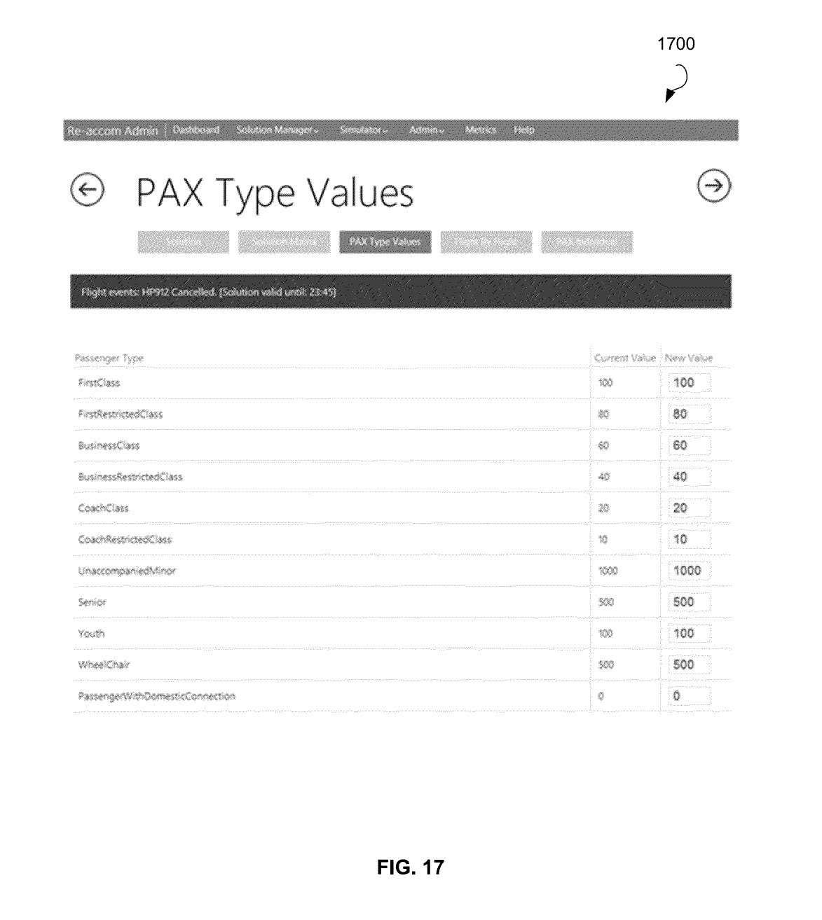

FIG. 17 shows a passenger type value screen 1700, in accordance with some embodiments. The screen 1700 shows attributes that may be associated with a specific type of passenger. Multiple attributes may be associated with one passenger. For example, a first class passenger may require a wheel chair. Each attribute may have a value associated with this attribute. The operator may modify the values for one or more attributes. After modifying the one or more values, the solution may be regenerated to reflect the changes.

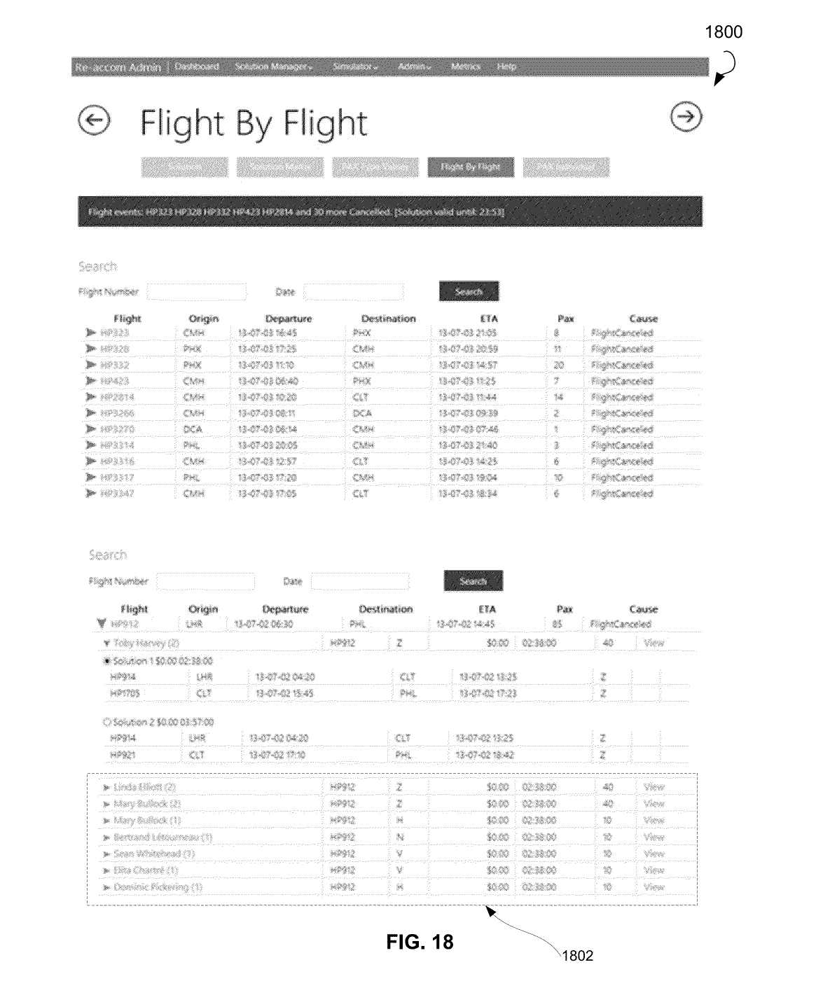

FIG. 18 shows a flight by flight screen 1800 providing reaccommodation details for each flight. When a flight shown on the screen 1800 is selected, a list of passengers 1802 may be displayed. The reaccommodation options generated for each passenger may be viewed. In some embodiments, passengers associated with different attributes may have a different number of reaccommodation options. For example, a business class passenger may have two options, while an economy class passenger may have only one option. The rules controlling this behavior may be configured, for example, such that the number of generated options is dependent on other attributes, or the number of options for each group is changed.

In some embodiments, reaccommodation options for each passenger may be reviewed and/or the passenger may be notified by the reaccommodation engine 200. The passengers having more than one reaccommodation option may select the desired option and send the selection to the reaccommodation engine 200. A further possible event associated with irregular operations is a flight delay. When a flight delay notification is received by the reaccommodation engine 200, an alert related to this event may be displayed on a dashboard screen 1100. The alert may indicate that the delay may cause connection issues for some passengers. A solution for all of the affected passengers may be automatically generated. To review the generated solution, the operator may use a solution screen 1500. Using a flight by flight screen 1800, the operator may review the details of reaccommodation options for each flight. When a specific flight is selected, an individual flight screen may be displayed.

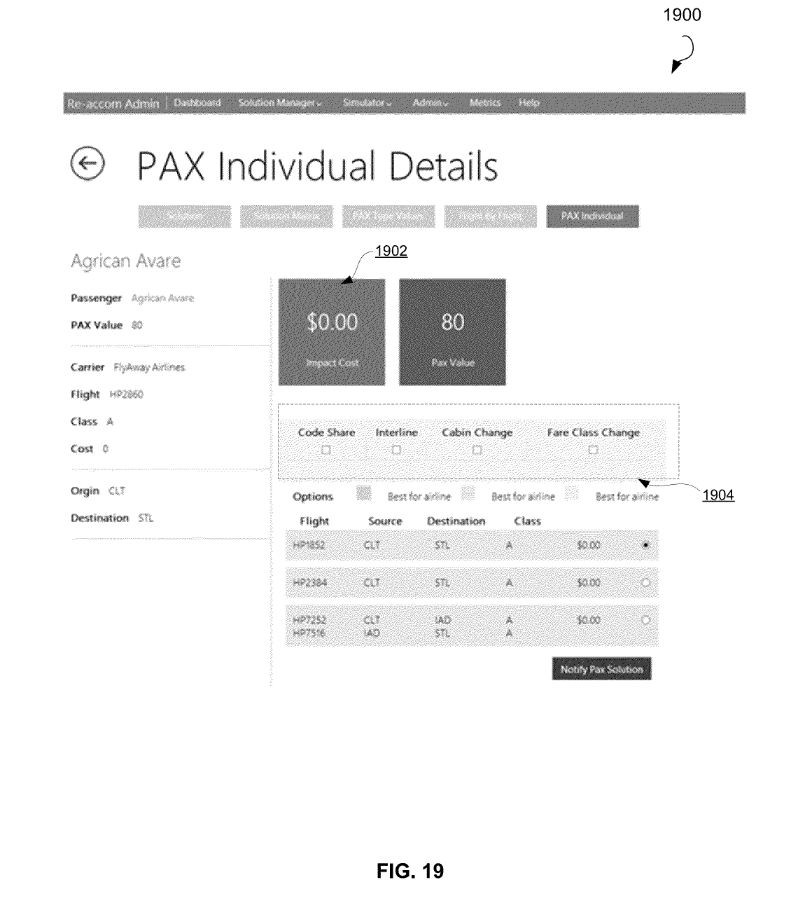

Additionally, the operator may select a specific passenger and view the options for that passenger as shown by FIG. 19. On the PAX individual details screen 1900, the operator may check financial impact 1902 of each reaccommodation option, adjust various settings 1904, such as a cabin change allowed/denied, fare class allowed denied, and so forth. Additionally, the operator may notify the passenger of the reaccommodation options available for that passenger. If the passenger has more than one reaccommodation option, he may select the desired option. The desired option may be sent to the reaccommodation engine 200. Thus, passengers may take part in the reaccommodation process by selecting the options that are more convenient for them.

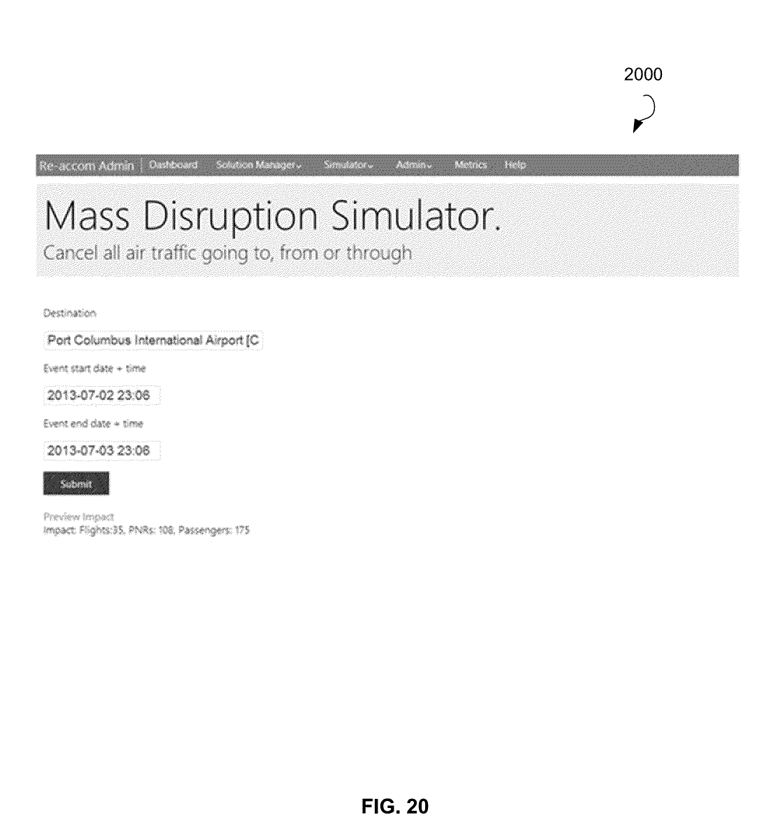

A further possible scenario associated with irregular operations may involve a mass disruption caused by an airport shutdown. For example, an airport shutdown event may be introduced by an operator via a mass disruption screen 2000 as shown by FIG. 20. Alternatively, the event may be triggered automatically based on transportation information received by the reaccommodation engine 200.

A notification concerning the event may be displayed in the events sections on a dashboard screen 1100 (illustrated by FIG. 11). The notification may include a short description of the event, affected flights, and other data. The operator may review the solution automatically generated by the reaccommodation engine 200 on a solution screen 1500. The generated model may provide solutions for some flights and/or passengers.

In some embodiments, the operator may adjust the rules and restrictions via a solution matrix screen 1600 so that solution could be generated for all affected flights and/or passengers. For example, a restricted coach class rule may prevent solution generation for some passengers. The operator may release this rule and provide a command to generate a solution without a restriction to a coach class. With the rule relaxed, all passengers may have a solution for reaccommodation. If not, the operator may repeat the procedure, until all issues are addressed. Additionally, the operator may review the generated reaccommodation options on a flight basis using a flight by flight screen 1800.

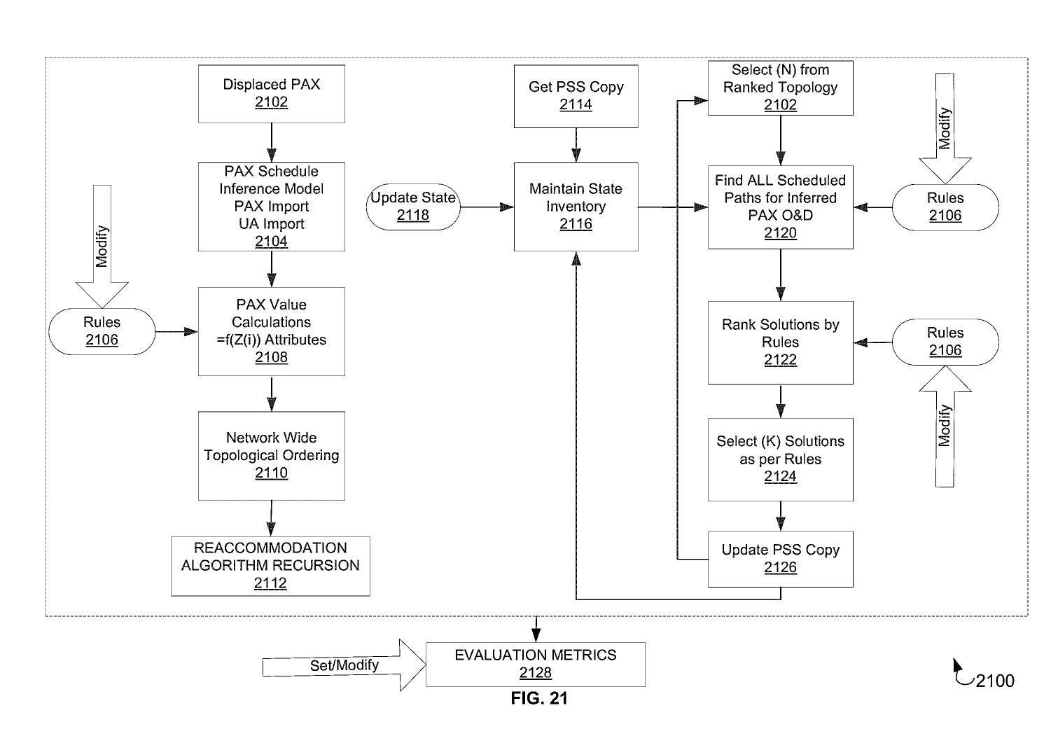

FIG. 21 illustrates a process 2100 of finding and ranking solutions, in accordance with some embodiments. When information concerning a displaced passenger (PAX) 2102 is received, the information may be transmitted to a PAX schedule, inference model, PAX import, and UA import 2104. Based on the information and rules 2106 (as modified from time to time), PAX value may be calculated 2108 according to attributes. The rules may include airline passenger ranking rules. Using the rules, the airline may set priorities for the passengers. This approach may provide an essentially additive model, based on a number of factors such as frequent flyer value, cash value of airline ticket, the impact of the disruption to the passenger, the financial cost of resolving or not resolving the reaccommodation to the airline, and so forth. The model can be additive in the sense that all the criteria that apply the result in their scores being added.

As a result of calculations 2108, a network wide topological ordering 2110 may be obtained. Each of the displaced PAX may be assigned a ranking score to be considered in priority determination. The network wide topological ordering 2110 may be injected into reaccommodation algorithm recursion 2112 to find reaccommodation options.

One or more passengers may be selected from the ranked topology 2122 for reaccommodation. Reaccommodation options may be searched based on real time data. To keep the data up-to-date, a PSS copy 2114 may be received. State inventory 2116 may be updated 2118 in real time. Using this approach, real time data can be used to find all scheduled paths for the inferred PAX origin and destination (O&D) 2120. The search may be performed based on the airline rules 2106, which are dynamic, since they are state-based and situational, e.g., a track policy. The found solutions may be ranked according to rules 2122. Additionally, the solutions may be ranked in order of preference to the airline across the network. Some solutions may be more expensive than others while others may provide less utility to the passenger. The airline can control the “cost-utility” of solutions as they choose the solutions using the rules 2106. Then, a predefined number (K) of options may be selected from the solutions 2224 to be provided to the passengers. The selection process may be based on the passenger profile. The number of options to be selected, which solutions are selected, and other details may be determined according to the rules 2106. For example, a global passenger may be entitled to a first class ticket regardless of whether he/she purchased one originally, whereas an economy class passenger may not be offered a first class seat as a reaccommodation option. After the options are provided and accepted by the passengers, PSS copy may be updated 2126.

When ranking solutions and/or selecting solutions are provided to passengers as reaccommodation options, various evaluation metrics 2128 may be applied. The evaluation metrics 2128 may include solution costs, influence on airline revenue, disservice metrics, and so forth.

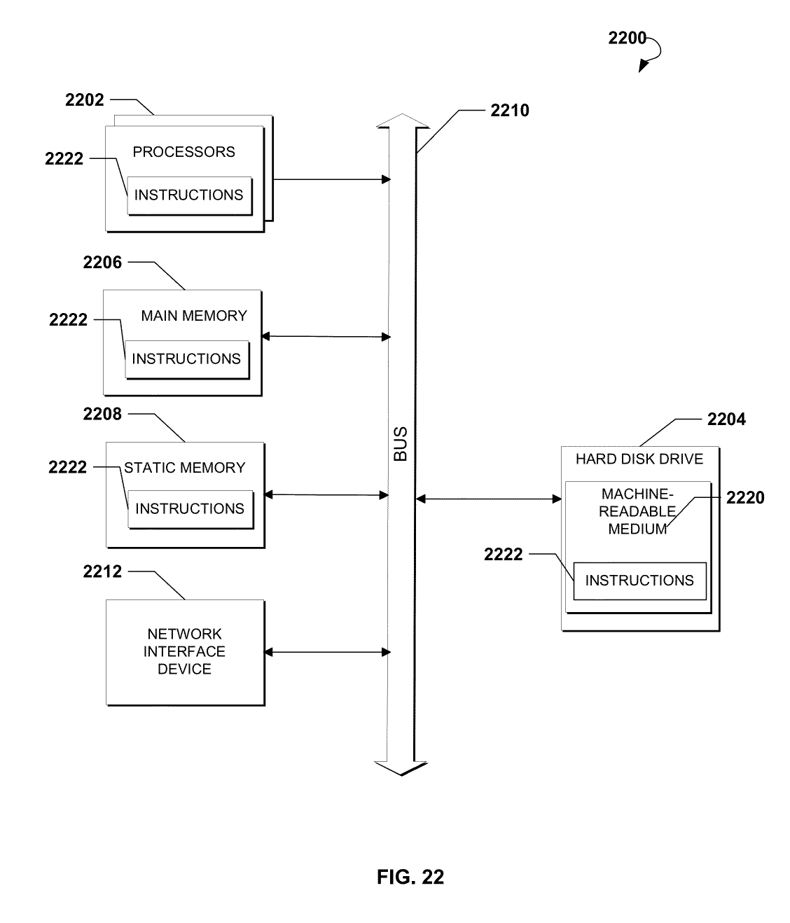

FIG. 22 shows a diagrammatic representation of a machine in the example electronic form of a computer system 2200, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a PC, a tablet PC, a set-top box (STB), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2200 includes a processor or multiple processors 2202 (e.g., a CPU, a graphics processing unit (GPU), or both), a main memory 2206 and a static memory 2208, which communicate with each other via a bus 2210. The computer system 2200 may further include a video display unit 2210 (e.g., a liquid crystal display (LCD) or a cathode ray tube (CRT)). The computer system 2200 may also include an alphanumeric input device 2212 (e.g., a keyboard), a cursor control device 2214 (e.g., a mouse), a hard disk drive unit 2204, a signal generation device 2228 (e.g., a speaker), and a network interface device 2212.

The hard disk drive unit 2204 includes a non-transitory computer-readable medium 2220, on which is stored one or more sets of instructions and data structures (e.g., instructions 2222) embodying or utilized by any one or more of the methodologies or functions described herein. The instructions 2222 may also reside, completely or at least partially, within the main memory 2206 and/or within the processors 2202 during execution thereof by the computer system 2200. The main memory 2206 and the processors 2202 may also constitute machine-readable media.

The instructions 2222 may further be transmitted or received over a network 2226 via the network interface device 2212 utilizing any one of a number of well-known transfer protocols (e.g., Hyper Text Transfer Protocol (HTTP)).

In some embodiments, the computer system 2200 may be implemented as a cloud-based computing environment, such as a virtual machine operating within a computing cloud. In other embodiments, the computer system 2200 may itself include a cloud-based computing environment, where the functionalities of the computer system 2200 are executed in a distributed fashion. Thus, the computer system 2200, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners, or such systems may be accessible to outside users who deploy applications within the computing infrastructure to obtain the benefit of large computational or storage resources.

The cloud may be formed, for example, by a network of web servers that comprise a plurality of computing devices, such as the computing device 130, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

The corresponding structures, materials, acts, and equivalents of all means or steps, plus function elements in the claims below, are intended to include any structure, material, or act for performing the function in combination with other claimed elements as specifically claimed. The description of the present technology has been presented for purposes of illustration and description, but is not intended to be exhaustive or limited to the disclosure. Many modifications and variations will be apparent to those of ordinary skill in the art without departing from the scope and spirit of the disclosure. Exemplary embodiments were chosen and described in order to best explain the principles of the present technology and its practical application, and to enable others of ordinary skill in the art to understand the disclosure for various embodiments with various modifications as are suited to the particular use contemplated.

Aspects of the present technology are described above with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Thus, computer-implemented methods and systems for reaccommodation of passengers during irregular operations are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

1. A method for reaccommodating of at least one passenger affected by irregular operations, the method comprising:
continuously receiving transportation information from a transportation system;
based on the transportation information, determining at least one reaccommodation event associated with the irregular operations according to predefined rules;
determining the at least one passenger affected by the at least one reaccommodation event;
receiving data concerning the at least one passenger;
based on the data, prioritizing the at least one passenger;
based on the prioritizing and the transportation information, generating at least one reaccommodation option for the at least one passenger;
providing the at least one reaccommodation option to the at least one passenger;
receiving from the at least one passenger, a selection of the at least one reaccommodation option; and
reaccommodating the at least one passenger based on the selection in real time.

2. The method of claim 1, wherein the data includes personal data associated with the at least one passenger, itinerary information, and status information.

3. The method of claim 1, wherein the transportation information includes airline network data, available flights data, available seat data, and pricing data.

4. The method of claim 1, wherein the irregular operations include at least one of the following: disruptions of passenger itineraries associated with weather conditions, flight delays, flight cancellations, irregular operations related to at least one the following: re-planning for scheduling and finance, re-allocating an aircraft, re-allocating a flight crew, and re-allocating maintenance.

5. The method of claim 1 further comprising:
analyzing, by the one or more processors, the data; and
based on the analysis, assigning at least one item of the data at least one predetermined value according to priority factors, wherein the prioritization is based on the analysis and the at least one predetermined value.

6. The method of claim 5, wherein the priority factors include at least one of the following: a passenger is a very important person (VIP), a passenger is in danger of missing a connection, and a passenger has a medical condition.

7. The method of claim 1, wherein the at least one reaccommodation option is provided for the at least one passenger by one or more of the following: an email message, a notification via a mobile application, and a push message to mobile devices associated with the at least one passenger.

8. The method of claim 1, wherein the at least one reaccommodation option includes at least one of the following: a different fare class, a different cabin class, and a different flight.

9. The method of claim 1, wherein the at least one reaccommodation option is associated with an additional charge or a compensation according to a wait time.

10. The method of claim 1, wherein the prioritizing is associated with prioritization rules and restrictions, the prioritization rules and restrictions being predefined by an airline.

11. The method of claim 10, wherein the prioritization rules and restrictions are associated with a plurality of fields and combination of fields, each of the plurality of fields and combination of fields being assigned a value.

12. A reaccommodation engine for irregular operations, the reaccommodation engine comprising:
at least one processor configured to:
continuously receive transportation information from a transportation system;
based on the transportation information, determine at least one reaccommodation event associated with the irregular operations according to predefined rules;
determine at least one passenger affected by the at least one reaccommodation event;
receive data concerning the at least one passenger;
based on the data, prioritize the at least one passenger;
based on the prioritizing and the transportation information, generate at least one reaccommodation option for the at least one passenger;
provide the at least one reaccommodation option to the at least one passenger;
receive from the at least one passenger, a selection of the at least one reaccommodation option; and
reaccommodate the at least one passenger based on the selection in real time; and
a database in communication with the at least one processor and configured to store at least the transportation information, the data, and the predefined rules.

13. The reaccommodation engine of claim 12, wherein the data includes at least one of the following: personal data associated with the at least one passenger, itinerary information, and status information.

14. The reaccommodation engine of claim 12, wherein the transportation information includes at least one of the following: airline network data, available flights data, available seats data, and pricing data.

15. The reaccommodation engine of claim 12, wherein the irregular operations include one or more of the following: disruptions of passenger itineraries associated with weather conditions, flight delays, flight cancellations, the irregular operations being related to at least one of the following: re-planning for scheduling and finance, re-allocating an aircraft, re-allocating a flight crew, and re-allocating maintenance.

16. The reaccommodation engine of claim 12, wherein the selection includes accepting the at least one reaccommodation option, asking for at least one alternative reaccommodation option, and declining at least one reaccommodation option.

17. The reaccommodation engine of claim 12, wherein the at least one reaccommodation option includes at least one of the following: a different fare class, different cabin class, and a different flight.

18. The reaccommodation engine of claim 12, wherein the at least one processor is further configured to re-generate at least one reaccommodation option for the at least one passenger.

19. The reaccommodation engine of claim 12, wherein the at least one reaccommodation option is associated with an additional charge or a compensation according to a wait time.

20. A non-transitory computer-readable medium comprising instructions, which when executed by one or more processors, perform the following operations:
continuously receive transportation information from a transportation system;
based on the transportation information, determine at least one reaccommodation event associated with irregular operations according to predefined rules;
determine at least one passenger affected by the at least one reaccommodation event;
receive data concerning the at least one passenger;
based on the data, prioritize the at least one passenger;
based on the prioritizing and the transportation information, generate at least one reaccommodation option for the at least one passenger;
provide the at least one reaccommodation option to the at least one passenger;
receive from the at least one passenger, a selection of the at least one reaccommodation option; and
reaccommodate the at least one passenger based on the selection in real time.
